(19) United States
(12) Patent Application Publication
(10) Pub. No.: US 2010/0068058 A1
(43) Pub. Date: Mar. 18, 2010

(54) BLADE WITH HINGED BLADE TIP

(75) Inventor: Tommy Sørensen, Lemming (DK)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: LM GLASFIBER A/S, Lunderskov (DK)

(21) Appl. No.: 11/922,320

(22) PCT Filed: Jun. 16, 2006
(86) PCT No.: PCT/DK2006/000348

§ 371 Date: Nov. 25, 2009

(30) Foreign Application Priority Data
Jun. 17, 2005 (DK) PA 2005 00899

(51) Int. Cl. F03D 7/02; F03D 1/06; F03D 9/00

(52) U.S. Cl. 416/41; 416/147; 290/55

(57) ABSTRACT

The present invention relates to a blade (202) for a wind power plant (201) comprising a controllable actuator and at least one joint (206) transversally of the longitudinal direction of the blade, about which joint the outermost part (205) of the turning of the blade at an angle out of the original face of rotation of the blade can be controlled by the actuator. Hereby the rotor area can he controlled continuously during operation, and the distance between the blade tip and the tower can be increased/reduced. The turning and the bracing of the joint is controlled by means of wire pulls and/or actuators, such as eg electric, pneumatic or hydraulic pistons. The invention also relates to a method of improving the operation of a wind power plant in operation, using the same mechanism.

The invention relates to a blade for a state-of-the-art wind power plant with improving operating properties and a wind power plant with such blade. The invention also relates to a method of improving the operation of a wind power plant in operation.

### BACKGROUND

The power output obtainable with a wind power plant depends directly on the size of the rotor area and hence of the effective length of the blades. 1% shorter length of a blade thus means, as a rule of thumb, a 2-3% reduction in power output. As a result of efforts to save material and weight, the blades on a wind power plant are often very flexible and their flexing due to wind can thus be quite considerable. The blade deformation therefore leads to a reduction in the rotor area and hence to an undesired reduction in the power yield.

Moreover the blade deformation is often a dimensionally restrictive factor in the design of new wind power plants since one has to make sure that the blades do not hit the tower. Arrangement of the rotor further away from the tower is undesirable, since an increased length of the main shaft gives rise to an increased momentum on the tower and undesired forces is in gear and bearings in the hub.

Depending on the wind speed it may thus be desirable both to increase the rotor are to utilize the wind to a higher degree and to increase the power output (in case of low wind speeds) and to change the shape of the blades in order for them not to hit the tower (in case of high air speeds).

It is known from EP 1019631 to manufacture precurved blades, which to some extent compensate for the flexing caused by wind. However, the full net length of the blade is still obtained only at the specific design wind speed. In case of all other wind speeds the blade will still either flex into the wind or rearwards.

A further method of changing the rotor diameter of a wind power plant is known from wind power plants with telescope-like blades that can be shifted out or in response to the wind conditions. However, this principle involves that, purely from a space point of view, the blade parts have be shifted into each other, which is not ideal. Yet a drawback is that of the rigidity of a blade and hence its yield changing quite dramatically by having a wing part accommodated fully or partly therein. Thus, it is impossible to design a telescopic blade with optimal rigidity properties in all of its configurations.

DE 3150715 teaches a wind power plant where the outermost part of the blades can be turned about a hinge at an angle of preferably 45° compared to the longitudinal axis of each blade. Each blade tip is balanced by a spring and a counterweight arranged outside the blade, whereby the blade tip is able to set in three main settings and hence influence the number of revolutions: at low wind speeds and during start-up the end of the blade will be turned slightly up against the wind in order to thereby provide an improved rotation momentum, in normal operation the blade will be straightened, and in case of elevated wind speeds the wind will bend the blade tip further, which will have a braking effect. However, here the structure means that the rotor area of the wind energy plant is reduced both in case of low and high wind speeds. Likewise, the risk is increased of the blade colliding with the tower, as the wind turns the blade tip. Finally the structure described, featuring counterweights and springs arranged outside the blade, is disadvantageous from the points of view of aerodynamics and operation.

### OBJECT AND DESCRIPTION OF THE INVENTION

It is the object of the invention to provide a blade for a wind power plant, obviating the above-mentioned problems of reduction of the rotor area caused by flexing of the blade. It is yet a further object to be able to regulate the distance between blade and the tower of the wind power plant when desired.

The present invention thus relates to a blade for a wind power plant which comprises at least one controllable actuator arranged interiorly of the blade, including eg an electric, hydraulic and/or pneumatic piston and at least a joint transversally to the longitudinal direction of the blade, about which joint the outermost part of the turning of the blade out of the original face of rotation of the blade can be controlled by the actuator whereby the rotor area can be controlled in operation.

By the method the advantage is obtained that the blade tip can be turned at different angles while the wind power plant is in operation and thereby change the shape of the blade to optionally compensate for the flexing of the blade by the wind. Hereby the rotor area can be maximised at different wind speeds, whereby a higher power yield can be accomplished. Such turning can be up against the wind to compensate for the flexing by the wind or down with the wind in case of relatively low wind speeds if the blades are too curved. Yet an advantageous function of the blade according to the invention is that the blade tip can also be turned so much that the rotor area is reduced which may be desirable in case of high wind speeds where it is desired to reduce the loads. Additionally, the turning of the blade tip may serve as a brake on the wind power plant. Turning of the blade tip as described by the invention is also advantageous as an easy and efficient way in which to increase the distance between the blade tips and the tower in operation, which distance may be a limited and dimensioning parameter, in particular in case of high wind speeds. Thus it is possible to arrange the rotor closer to the tower and reduce the length on the main shaft of the wind power plant, which in turn results in a reduction of the forces and the loads on gear and bearings. Moreover, in accordance with the invention such joint means that the blades can be manufactured to be more elastic, whereby savings are obtained both on weight and material with ensuing lower production costs. When the blade tip is rotated all the way to perpendicular to the longitudinal direction of the blade, it is further accomplished that the blade tip may serve as a winglet with noise-reducing and performance-increasing properties. Finally, turning of the blade tip will facilitate transport of the now somewhat shorter blade from its site of production to the site of deployment of the wind power plant. The turnings of the blade tips can be controlled individually or jointly by means of the controllable actuators or as a function of the wind speed locally or averagely, but also as a function of a vast number of other operation parameters, e.g. the loads on the blade, vibrations, the noise, the current wind gradient, blade flexing, turbulence intensity, the yaw error, the pitch angle, the yaw position, turbine output, air density or the current number of revolutions of the turbine.

The invention further relates to a blade for a wind power plant according to the above, wherein the joint is arranged approximately along the cord of the blade profile. Hereby it is possible for the joint to move, as it enables a turning of the joint with pull forces as well as pressure forces.

According to yet an embodiment the joint in the blade according to the above is arranged at an angle of between −60° and +60° relative to the longitudinal direction of the blade and arranged at a distance from the root of the blade of between 80% and 90% of the length of the blade.

Moreover, the invention relates to a blade for a wind power plant according to the above which is, at least around the joint, made from an elastic material, such as eg rubber. Hereby a smooth transition is accomplished from the non-turned to the turned part of the blade with minimal disruption of the flow picture of the wind around the blade, whereby the loss of power due to the rotation as such is minimised. Also, such smooth transition entails that the noise is reduced compared to an edged or non-elastic transition between the blade and the blade tip.

According to yet an embodiment of the invention, the blade comprises a rotary joint or a resilient joint of a certain expanse in the longitudinal direction of the blade. By the latter a rather gradual turning of the blade is accomplished with ensuing smaller requirements to the elasticity of the material of the blade shell.

Moreover, the invention relates to a blade for a wind power plant as described above, wherein the blade comprises an actuator, including eg an electric, hydraulic or pneumatic piston, configured for being able to either brace the joint. Hereby it is accomplished in a simple and effective partly manner that the blade tip can be secured in the desired position.

According to yet an embodiment, the tip of the blade may, as described above, be turned about the joint by means of one or more wire pulls, which is a simple and inexpensive method of accomplishing the requisite power transfer.

Moreover, the present invention relates to a wind power plant with a blade according to one or more of the embodiments described above.

Moreover, the present invention relates to a method of improving the operation of a wind power plant comprising that the outermost part of the turning of the blades about at least a joint transversally to the longitudinal direction of the blade at an angle outside the original face of rotation of the blade is controlled by at least one controllable actuator, whereby the rotor area is controlled during operation. Hereby the rotor area can be changed and/or increased, or the clearance between blade and the tower on the wind power plant is increased. The advantages of this are as described above in the context of a blade for a wind power plant.

The invention further relates to methods according to the above further comprising measuring the wind speed and/or the blade deformation and, based on that, determining the turning of the blade tip. Hereby the advantage is obtained that the angulation of the blade tip giving the optimum overall shape of the blade can be determined continuously as a function of the wind speed and the behaviour of the blade.

According to yet an embodiment the joint is braced relative to the blade tip by means of at least one actuator, whereby the angulation of the blade tip can be controlled and maintained effectively.

Finally, the invention also relates to a method according to the above and comprising that the blade tip can be rotated about an axis approximately in parallel with the longitudinal axis of the blade tip. Hereby a further option is made available of how to turn the blade tip, which may be advantageous if the blade is eg pitched or twisted.

### BRIEF DESCRIPTION OF THE DRAWING

In the following the invention is described with reference to the figures, wherein

FIG. 1 shows a typical power curve for a wind power plant;

FIG. 2 shows a wind power plant, seen in an inclined front view, with turned blade tips in accordance with the invention;

FIG. 3 shows a wind power plant from the hub and downwards, seen inwards from the side, and with turned blade tips for changing the rotor area in accordance with the invention;

FIG. 4 shows a wind power plant from the hub and downwards, seen inwards from the side, and with precurved blades, whose blade tips are turned to increase the rotor area according to the invention;

FIG. 5 shows a wind power plant from the hub and downwards, seen inwards from the side, and with turned blade tips for increasing the distance between blade tip and tower in accordance with the invention;

FIG. 6 shows the outermost part of a blade for a wind power plant according to the invention—seen on the one hand from above and, on the other, inwards from the side.

FIG. 7 shows a further embodiment of the outermost part of a blade for a wind power plant according to the invention—seen on the one hand from above and, on the other, inwards from the side;

FIG. 8 shows the outermost part of a blade for a wind power plant with a resilient joint according to the invention—seen on the one hand from above and, on the other, inwards from the side;

FIG. 9 shows an alternative embodiment of the outermost part of a blade for a wind power plant with two joints in succession—seen on the one hand from above and, on the other, inwards from the side; and

FIG. 10 shows the same as FIG. 9, but with another location of the turnable joints—seen on the one hand from above and, on the other, inwards from the side.

### DESCRIPTION OF EMBODIMENTS

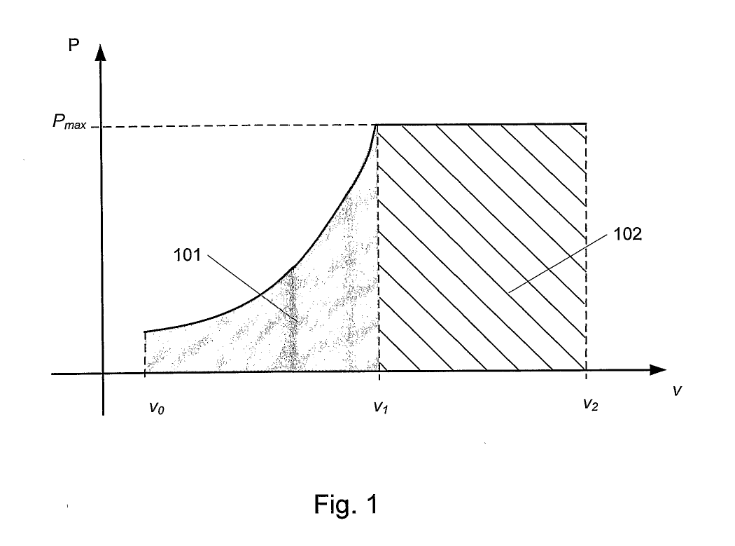

FIG. 1 schematically shows a typical power curve for a wind power plant. The curve shows the obtained power P as a function of the wind speed v. The wind power plant starts to produce current at a start wind having the speed V₀ and the power yield increases from there with increasing wind speeds until the speed V₁. In this area 101 the wind power plant is structured to maximize the power output and productivity of the wind power plant. At the wind speed V1 the wind power plant yields the maximum power Pₘₐₓ. The magnitude of this speed depends on various factors such as financial factors, including eg the size of the generator, and local wind conditions where the wind power plant is to be erected. From that wind speed V₁ and until the stop wind V₂, the wind power plant is constructed to yield a constant maximum effect Pₘₐₓ. The additional power which could in fact be derived from the high wind speeds is usually not exploited as it is not profitable compared to, on the one hand, the frequency of such elevated wind speeds and, on the other, the additional production costs, caused by the correspondingly higher wind loads in the form of stronger gears, tower, generator, etc. In this area 102, at speeds between V₁ and V₂, the wind power plant is thus usually structured to minimize the loads on the wind power plant. Likewise, the wind power plant with relatively flexible blades is most often also dimensioned to take into consideration that the blades must not be deformed and flex so much that they can hit the tower (dimensioned in view of flexing) which is a considerable parameter precisely in area 102 at the high wind speeds.

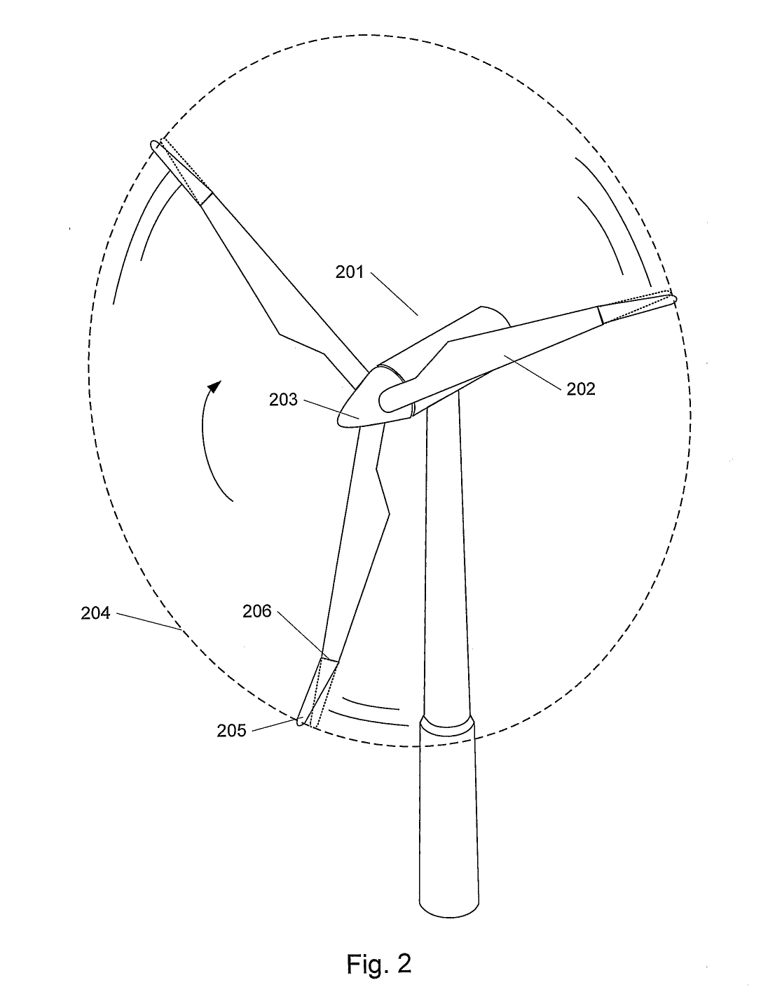

FIG. 2 shows a wind power plant 201 with three blades 202 sitting in the hub 203 and rotating along with it. The size of the area—the rotary area 204—swept by the blades 202 is determining for how much energy the wind power plant Is able to extract from the wind and hence for its power output. According to a rule of thumb, a radius which is smaller by 1% will mean a reduction in the power produced of 2-3%. The effective length of the blades is thus crucial to the productivity of a wind power plant. Depending on which material is used for the blades 202, they may possess considerable flexibility, which in turn leads to comparatively large deformations and flexings of the blade tip due to the wind loads. As an example it can be mentioned that a glass fibre blade with a length of 30 meters is able to flex as much as 6 m in case of wind speeds corresponding to ordinary operating conditions. Hereby the flexing considerably reduces the rotor area 204. In order to compensate for the deformation of the blade, each blade 202 is, according to one embodiment of use of the present invention, provided with a joint 206 about which the blade tip 205 can be turned. The face swept by the blade without the blade tip being turned is designated the original face of rotation. According to that embodiment of use, the blade tip 205 is turned out of the original face of rotation, thereby increasing the rotor area.

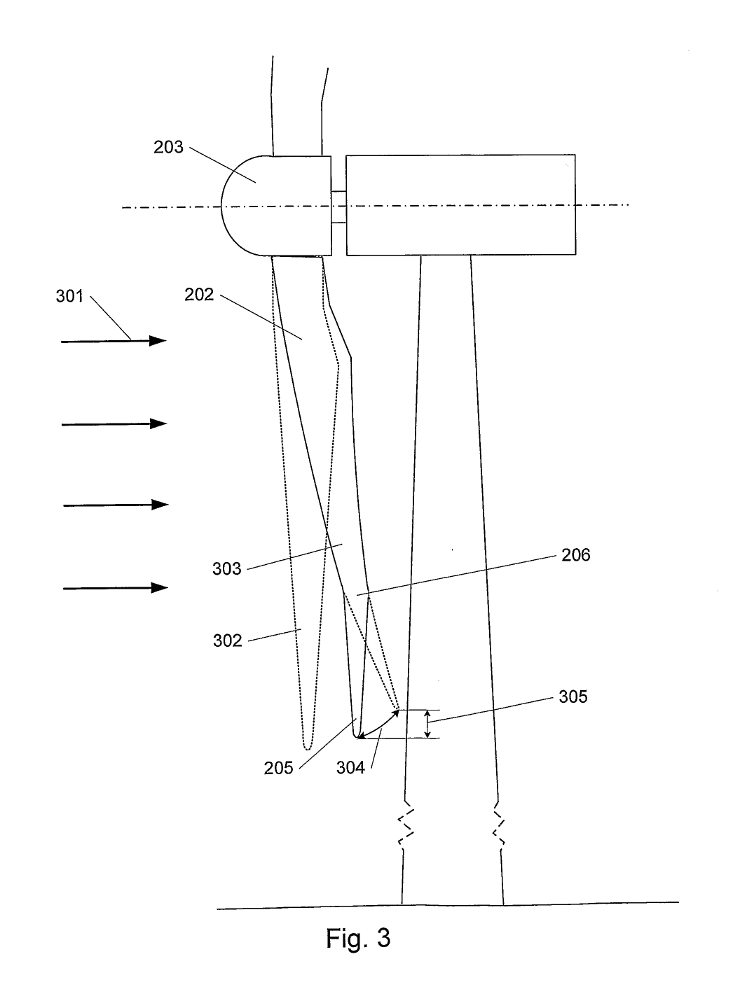

This will also appear from FIG. 3 which shows the lowermost part of a wind power plant 201 in a side view. The wind energy plant is turned up against the wind, whose direction is indicated by arrows 301. The blade 202 is outlined in non-deformed state by dotted lines 302 and in deformed state 303. Here the blade tip is turned an angle 304 up against the wind about a joint 206 arranged a distance up the blade. As shown in the figure, such turning results in an increase 305 of how far the blade extends from the hub and hence in a corresponding increase in the rotor area. Preferably the joint 206 is arranged at a distance from the hub of between 80% and 90% of the overall length of the blade. According to the invention a blade can also be provided with several joints.

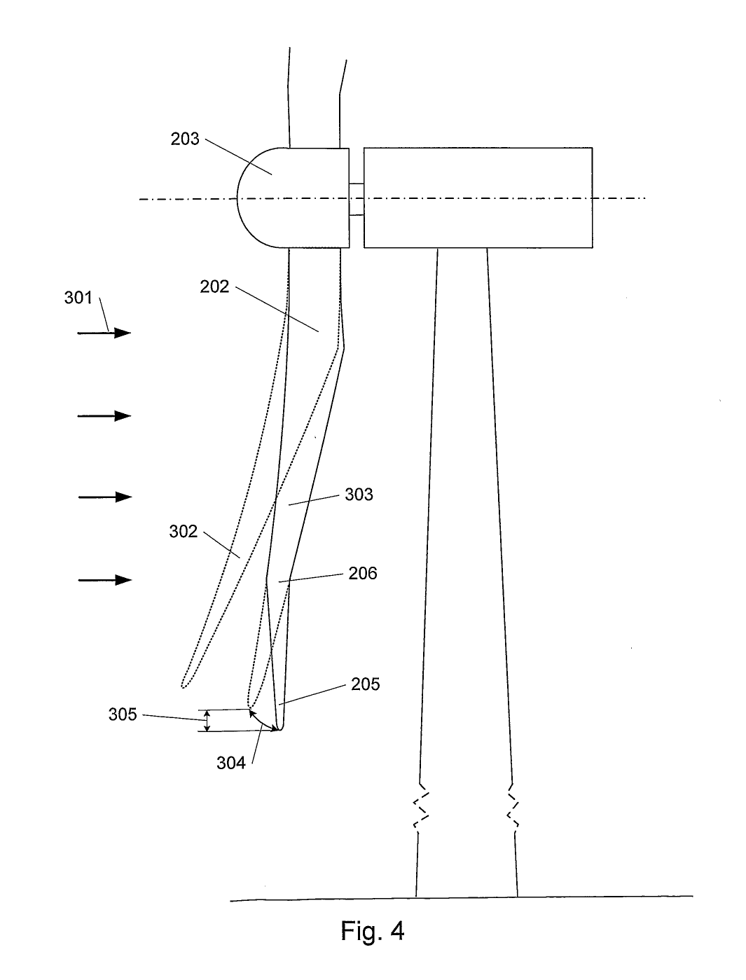

FIG. 4 shows a wind power plant with precurved blades 202. Again, dotted lines show a non-deformed blade 302 and fully drawn lines show the blade 303 deformed by the blade 301. In case of low wind speeds the precurved blades are not yet sufficiently deformed to flex, whereby a maximum rotor area can be accomplished. In that case, the rotor area can be increased by turning the outermost part 205 of the blade at an angle 304 about a joint 206 resulting in an increase 305 of how far the blade extends from the hub 203. Here the blade tip 205 is turned in a direction with the wind 301.

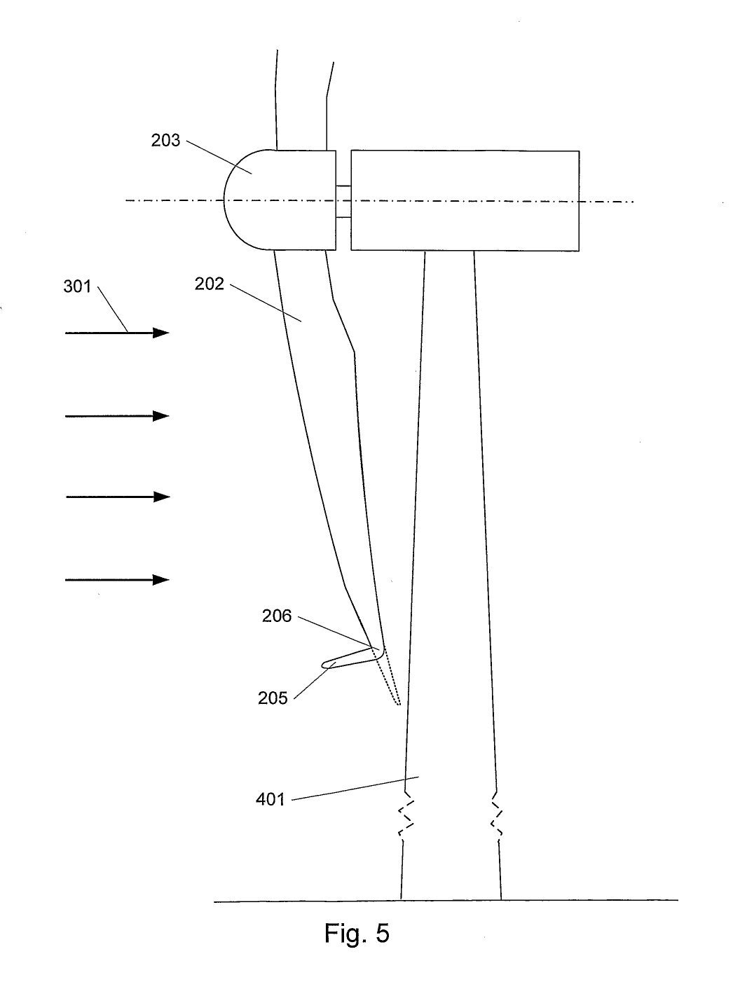

A blade with hinged blade tip as shown in the preceding figures can also be used with a view to increasing the distance of the blades to the tower. This is illustrated in FIG. 5 where, like in FIGS. 3 and 4, a wind power plant is shown in a side view with a blade 202 in the lowermost position. The wind power plant is turned against the wind with the wind direction 301 which flexes the blade in a direction towards the tower 401. To the one side, it is, of course, undesirable that the blades hit the tower during their rotation. On the other hand, it is desired that the blades 202 and the hub 203 be placed as close to the tower 401 as possible to be able to reduce the length of the main shaft and hence reduce the loads and the forces in gears and bearings. When it is possible to turn the blade tips about a joint 206, the critical distance between blades 202 and tower 401 is increased. Moreover, a turning may serve as a brake on the wind power plant, which may be desirable in particular in case of high wind speeds. Finally the blade tip 205 may serve as a winglet by being turned approximately perpendicular to the remainder of the blade as outlined in FIG. 5. Winglets are known in particular from cars and aeroplanes and have the effect that they minimize vortex formation around the tip of the blade and hence considerably reduce the noise from the rotating blades and increase the aerodynamic performance.

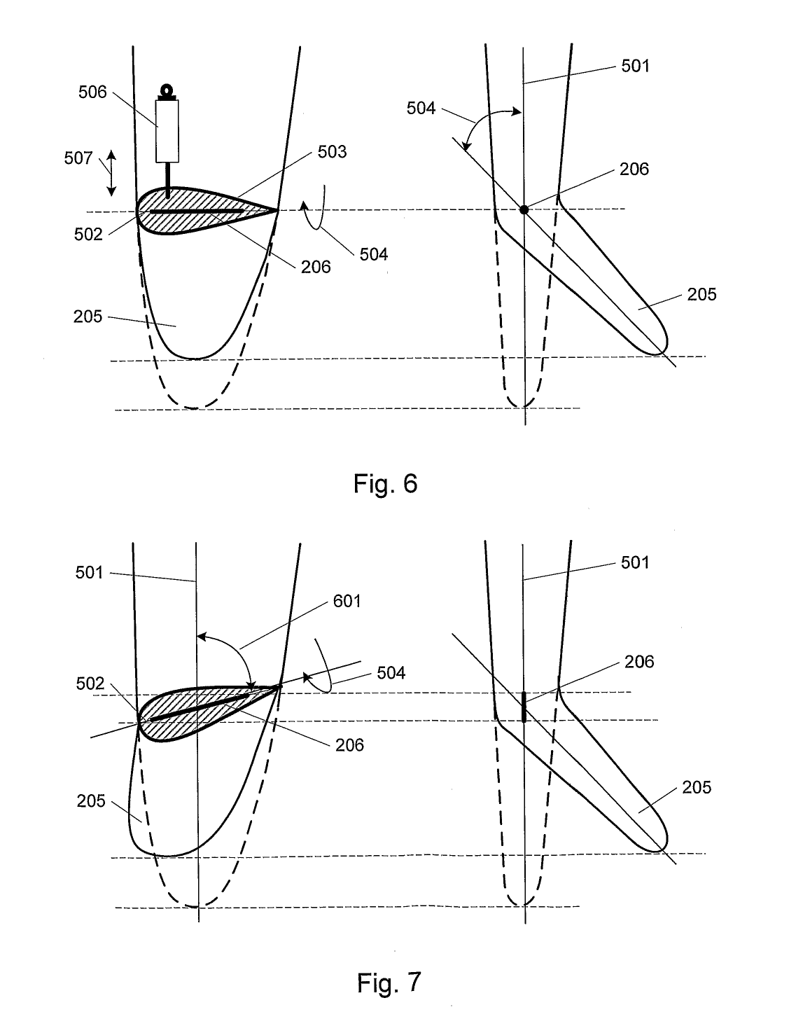

FIGS. 6-10 show different embodiments of a blade with one or more joints 206 according to the invention. It is common to these figures that they show the outermost part of a blade, seen on the one hand from above perpendicular to the longitudinal direction 501 of the blade and the cord 502 of the blade profile (shown to the left) and, on the other, seen inwards from the blade edge (shown to the right). Dotted lines indicated the unflexed and partially flexed state of the blade tip.

FIG. 6 shows an embodiment, where a rotary joint 206 is arranged transversally of the longitudinal direction 501 of the blade. For instance, the joint may be configured as a hinge or the like. In the shown example the joint 206 is arranged approximately perpendicular to the longitudinal direction 501 of the blade, but it is also an option for it to be situated at an angle 601 relative to the longitudinal axis. This is illustrated in FIG. 7. Here, to the left in FIG. 6, the blade profile is shown laid down to clarify the location of the joint 206 along the cord 502 in the blade profile 503. It is also an option that the joint is arranged in some other manner, eg outermost in a section of the blade shell. The location of the joint determines the resulting position of the blade tip 205, and the optimal arrangement of the joint thus, on the one hand, depends on the wind speeds at which the joint is to be used and for which purpose (eg as winglet or to increase the rotor area) and, on the other, it depends on the specific design parameters of the blade, such as how much the blade twists along its length, whether the blade is pitch-regulated, the length/width ratio of the blade. In the example shown in FIG. 6, the rotary joint is turned at an angle 504. This can be controlled eg by means of one or more hydraulic pistons 506 that are able to move as illustrated by arrow 507. On the one hand, the piston can supply the power to turn the blade tip 205 the desired angle and, on the other, it braces the joint, counteracts the pressure from the wind, and secures the blade tip 205 in the desired position both in unturned and turned state. A hydraulic piston is may be arranged in the blade profile 503, both to exert pressure or pull. The requisite pull forces may also, according to another embodiment, be supplied via one or more wire pulls or by wire pull in combination with one or more pistons. Moreover other types of known actuators are possible for turning the blade tip.

The power mechanism for each blade is, according to one embodiment of the invention, connected to a central control unit which is, in turn, connected to a weather station. From here the control unit receives information about the wind speed, based on which the optimum turning of the blade tips is determined and controlled. Alternatively the control of the turning of the blade tips can also be based on measurements of the flexing or loads of the blades, which may eg be produced by continuous measurements on one or more blades with strain gauges, optical-fibre sensors or GPS or by measurements of the distance of a blade tip to the tower measured by eg infrared light or the like.

In order to ensure that the flow field is as undisturbed as possible around the blade, the blade shell is made of an elastic material in the area around the location of the joint. Hereby a continuous transition from the non-turned blade tip to the turned blade tip is accomplished. Moreover the original even surface on the blade is re-established when the blade reverts to its starting position. According to a further embodiment of the invention the entire blade tip is made from an elastic material. An example of this is rubber.

FIG. 7 illustrates a blade with a blade tip 205 which can be turned about a rotary joint 206 such as a hinge. As opposed to the embodiment shown in FIG. 6, the joint 206 is here still arranged transversally to the longitudinal axis 501 of the blade, but at an angle 601 relative to the longitudinal axis and not perpendicular thereto as shown in FIG. 6. This results in another turned configuration of the blade tip 205 which may, depending on whether and how much the blade is pitched or twisted, be more directly up against the wind and thus entail a larger resulting rotor area.

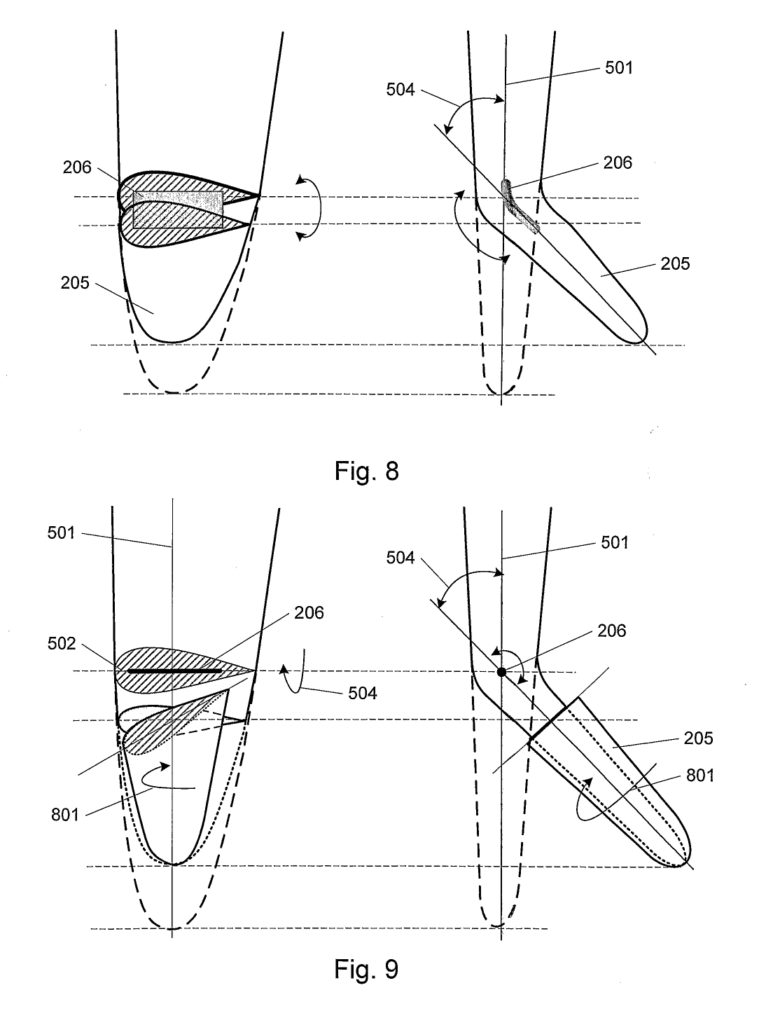

FIG. 8 shows an embodiment of the invention where the joint 206 in the blade is configured as a resilient joint of a certain expanse in the longitudinal direction 501 of the blade. The turning of the blade tip 205 thus takes place across a certain section of the blade. This may be advantageous, since the transition from the non-turned blade to the blade tip extends a longer distance and hence becomes increasingly gradual. Hereby the requisite elastic deformation of the blade shell material in each point can be reduced and the load on the material can be reduced correspondingly. The same resulting angulation 504 as was the case with a rotary joint as shown in preceding FIGS. 6 and 7, can be accomplished by this embodiment, and the turning can be controlled in the same manner by means of eg hydraulic pistons or other actuators and/or wire pulls.

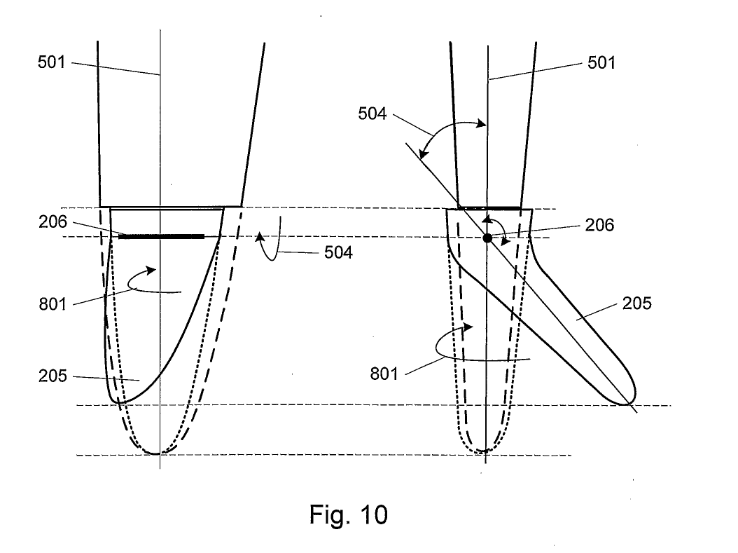

It is also possible to locate several joints in succession in the blade and thus to turn the blade tip in several passes or in several places simultaneously, which may also, as mentioned above, reduce the loads on the blade material. The turning of a blade tip 205 may also be combined with a rotation of the blade tip about the longitudinal axis 501 of the blade. This is illustrated in FIGS. 9 and 10. In FIG. 9 the blade tip 205 is first turned (most proximate the blade root) an angle 504 about a rotary joint 206 according to the invention transversally of the longitudinal axis of the blade, as described above. Then the blade tip is rotated about the longitudinal axis 501 of the blade as illustrated by arrows 801. In FIG. 10 the sequence of the two rotary joints is switched to the effect that the blade tip 205 is first rotated 801 about the longitudinal axis 501 and then it is turned about a rotary joint 206 transversally of the longitudinal axis of the blade with an ensuing other resulting turned position. How, how many and which types of joints that yield the optimum turning of the blade tip depends, as mentioned above, on several different parameters, such as the twist of the blade down along its length and on the purpose of the turning of the blade, which, in turn, depends on the current wind speed.

It will be understood that the invention as mentioned in the present description and figures can be modified or changed while continuing to be comprised by the scope of protection as defined by the following claims.

1. A blade (202) for a wind power plant, characterised in comprising at least one controllable actuator (506) arranged interiorly of the blade, including eg an electric, hydraulic and/or pneumatic piston and at least one joint (206) transversally of the longitudinal direction (501) of the blade, about which joint (206) the outermost part (205) of the turning of the blade at an angle out of the original face of rotation of the blade can be controlled by the actuator, whereby the rotor area (204) can be controlled in operation.

2. A blade for a wind power plant according to claim 1, wherein the joint (206) is arranged approximately along the cord (502) of the blade profile.

3. A blade for a wind power plant according to one or more of claims 1-2, wherein the joint (206) is arranged at an angle (601) of between −60° and +60° relative to the longitudinal direction (501) of the blade.

4. A blade for a wind power plant according to one or more of claims 1-3, wherein the joint (206) is located at a distance from the root of the blade of between 80% and 90% of the length of the blade.

5. A blade for a wind power plant according to one or more of claims 1-4, wherein the blade is, at least about the joint (206), manufactured from an elastic material, such as eg rubber.

6. A blade for a wind power plant according to one or more of claims 1-5, wherein the joint (206) comprises a rotary joint.

7. A blade for a wind power plant according to one or more of claims 1-6, wherein the joint (206) comprises a resilient joint with a certain expanse in the longitudinal direction (501) of the blade.

8. A blade for a wind power plant according to one or more of claims 1-7, wherein the blade comprises an actuator (506), including eg an electric, hydraulic or pneumatic piston configured for being able to brace the joint (206).

9. A blade for a wind power plant according to one or more of claims 1-8, wherein the blade comprises a wire pull configured for being able to turn the outermost part (205) of the blade about the joint (206).

10. A wind power plant featuring a blade according to one or more of claims 1-9.

11. A method of improving the operation of a wind power plant, characterised in comprising that the outermost part (205) of the turning of the blades about at least a joint (206) transversally of the longitudinal direction (501) of the blade at an angle out of the original face of rotation is controlled by at least one controllable actuator (50), whereby the rotor area (204) is controlled during operation.

12. A method according to claim 11, wherein the outermost part (205) of the blades is turned relative to the blade, whereby the area of rotation (204) is increased.

13. A method according to claim 11, wherein the outermost part (205) of the blades is turned relative to the wind, whereby the clearance between a blade (202) and the tower (401) on the wind power plant is increased.

14. A method according to one or more of claims 11-3, further comprising measuring the speed of the wind and, based on that, determining the turning of the blade tip.

15. A method according to one or more of claims 11-14, further comprising measuring the deformation of a blade and, based on this, determining the turning of the blade tip.

16. A method according to one or more of claims 11-15, further comprising bracing of the Joint (206) to the blade tip (205) by means of at least one actuator (506).

17. A method according to one or more of claims 11-16, further comprising rotating the blade tip (205) about an axis approximately in parallel with the longitudinal axis (501) of the blade.
